(19) United States
(12) Patent Application Publication
(10) Pub. No.: US 2006/0068143 A1
(43) Pub. Date: Mar. 30, 2006

(54) Adhesive notepad having sheets with reduced flagging characteristics

(76) Inventors: Ashok Chandaria, Nairobi (KE); Velji Chandaria, Nairobi (KE)

Correspondence Address: SAND & SEBOLT, AEGIS TOWER, SUITE 1100, 4940 MUNSON STREET, NW, CANTON, OH, 44718-3615, US

(21) Appl. No.: 10/950,983

(22) Filed: Sep. 27, 2004

(51) Int. Cl. B32B 33/00

(52) U.S. Cl. 428/40.1

(57) ABSTRACT

An adhesive notepad comprising a plurality of sheets of notepaper with first and second adhesive regions applied to the rear surface thereof. The second adhesive region is disposed at a spaced junction from the first adhesive region and is oriented to allow substantially the entire length of the rear surface of a sheet of notepaper to lie substantially in abutting contact with an outer surface of an object to which the sheet is applied. The first adhesive region may also include areas free of adhesive which

### BACKGROUND OF THE INVENTION

1. Technical Field

This invention generally relates to notepads. More particularly, the invention relates to notepads which comprise sheets having an adhesive applied to the rear surface and which may be individually removed from the notepad and applied to the outer surface of an object. Specifically, the invention relates to an adhesive notepad which comprises sheets which have more than one adhesive region applied to the rear surface and therefore has a reduced tendency to flag as well as notepads with shaped adhesive areas.

2. Background Information

Notepad sheets having an adhesive strip at one end are frequently used in business settings for writing brief notes relating to files or documents or for numerous other applications. These notepad sheets, or sticky notes as they are frequently referred to, have a tendency to flag when they are removed from the pad and then stuck to another surface. Flagging is the term given to the curling up of one corner of the sticky note and is the result of the “memory” of the paper. Flagging tends to cause the lower end of the sticky note to pull away from the outer surface of the object to which the note is applied. This makes the sticky note vulnerable to accidental removal from the object to which it has been applied. The amount of flagging of a sticky note depends upon the grade of paper from which it is made, the thickness of the paper and the type of release coating applied to the upper surface. The degree of flagging tends to relate to the stickiness of the adhesive, so that the stronger the adhesive used on the note, the greater the tendency of that note to flag when it is removed from the notepad. The quality of a sticky note is generally judged by how well it tends to grip the outer surface of an object as well as the degree to which the note tends to flag.

There is therefore a need in the art for an adhesive notepad in which the adhesive applied to the sheets is strong enough to allow for easy adherence to surfaces of objects, but which has a decreased tendency to flag when adhered to a surface.

### SUMMARY OF THE INVENTION

The adhesive notepad of the present invention comprises a plurality of sheets of notepaper that have a first and a second adhesive region applied to the rear surface of the sheets and to adhesive notepads comprising a plurality of sheets of notepaper that have less adhesive at the corners of the sheet. The location and orientation of the adhesive regions on the notepaper allows the rear surface of the sheet of notepaper to stay in abutting contact with the outer surface of the object to which the sheet is applied and will tend to reduce the tendency of the sheet to flag.

In a first embodiment of the invention, the first adhesive region is applied proximate the upper edge of the sheet and the second adhesive region is applied substantially along the midline of the sheet but in a direction perpendicular to the first adhesive region.

In a second embodiment of the invention, the first adhesive region is applied proximate the upper edge of the sheet and the second adhesive region comprises a plurality of discrete beads of adhesive distributed over the remainder of the rear surface of the sheets, preferably in rows and preferably proximate the side and lower edges of the sheet.

In a third embodiment of the invention, the first adhesive region is applied proximate the upper edge of the sheet and between the side edges of the sheet and the second adhesive region is applied proximate the lower edge of the sheet and substantially parallel to the first adhesive region.

In a fourth embodiment of the invention, the first adhesive region is applied proximate the upper edge of the sheet, but the upper corners of the sheet are adhesive free. The second adhesive region comprises a discrete bead of adhesive applied proximate each lower corners of the sheet.

In a fifth embodiment of the invention, the first and second adhesive regions are applied proximate the upper edge of the sheet and the regions are separated from each other by areas that are free of adhesive.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a sheet of adhesive notepaper in accordance with the prior art, showing flagging of the notepaper at one of the lower corners of the same;

FIG. 2 is a side view of the sheet of adhesive notepaper through line 2-2- of FIG. 1;

FIG. 3 is a perspective view of a sheet of adhesive notepaper in accordance with a first embodiment of the present invention, and showing a lack of flagging of the sheet;

FIG. 4 is a side end view of the sheet of adhesive notepaper through line 4-4- of FIG. 3;

FIG. 5 is a rear view of the sheet of adhesive notepaper of FIG. 3;

FIG. 6 is a rear view of a sheet of adhesive notepaper in accordance with a second embodiment of the present invention;

FIG. 7 is a rear view of a sheet of adhesive notepaper in accordance with a third embodiment of the present invention;

FIG. 8 is a rear view of a sheet of adhesive notepaper in accordance with a fourth embodiment of the present invention; and

FIG. 9 is a rear view of a sheet of adhesive notepaper in accordance with a fifth embodiment of the present invention.

### DETAILED DESCRIPTION OF THE INVENTION

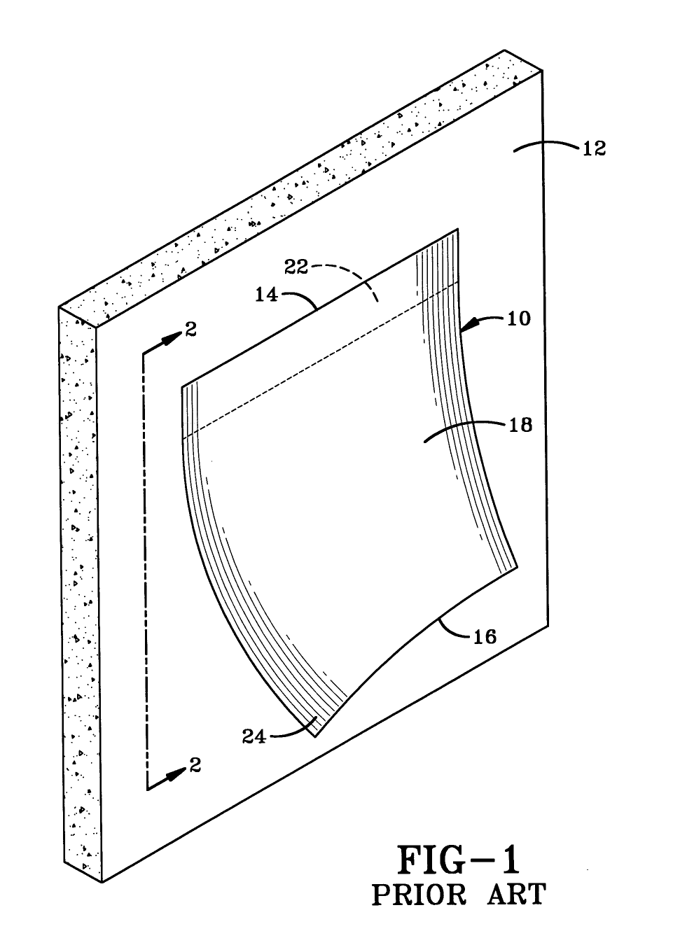

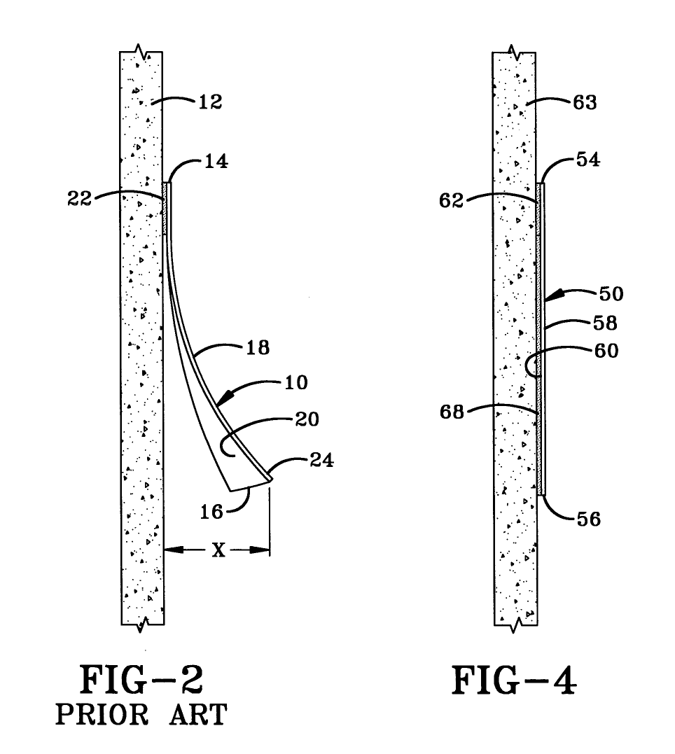

Referring to FIGS. 1-2, there is shown a sheet of adhesive notepaper in accordance with the prior art, generally indicated at 10 and applied to a surface 12. Sheet 10 has an upper edge 14, a lower edge 16, a front surface 18 and a rear surface 20. An adhesive strip 22 is applied on rear surface 20 proximate upper edge 14. It may be seen particularly from FIG. 2, that a lower corner 24 of sheet 10 of the prior art is flagging and thereby causing lower edge 16 of sheet 10 to lie a distance X outwardly from surface 12. This is undesirable as lower corner 24 may be snagged accidentally and thereby cause sheet 10 to peel off the surface 12.

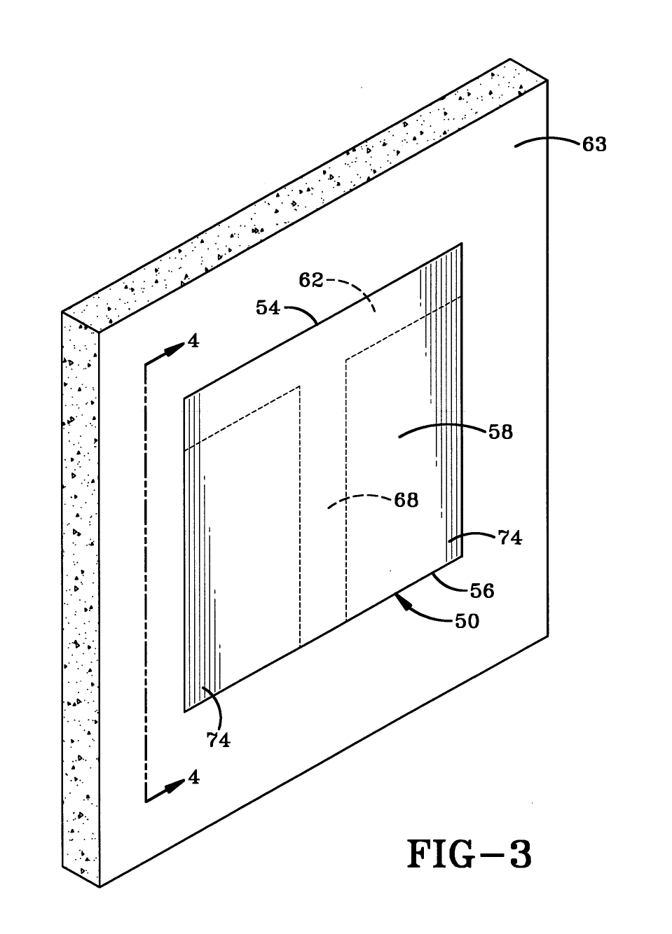

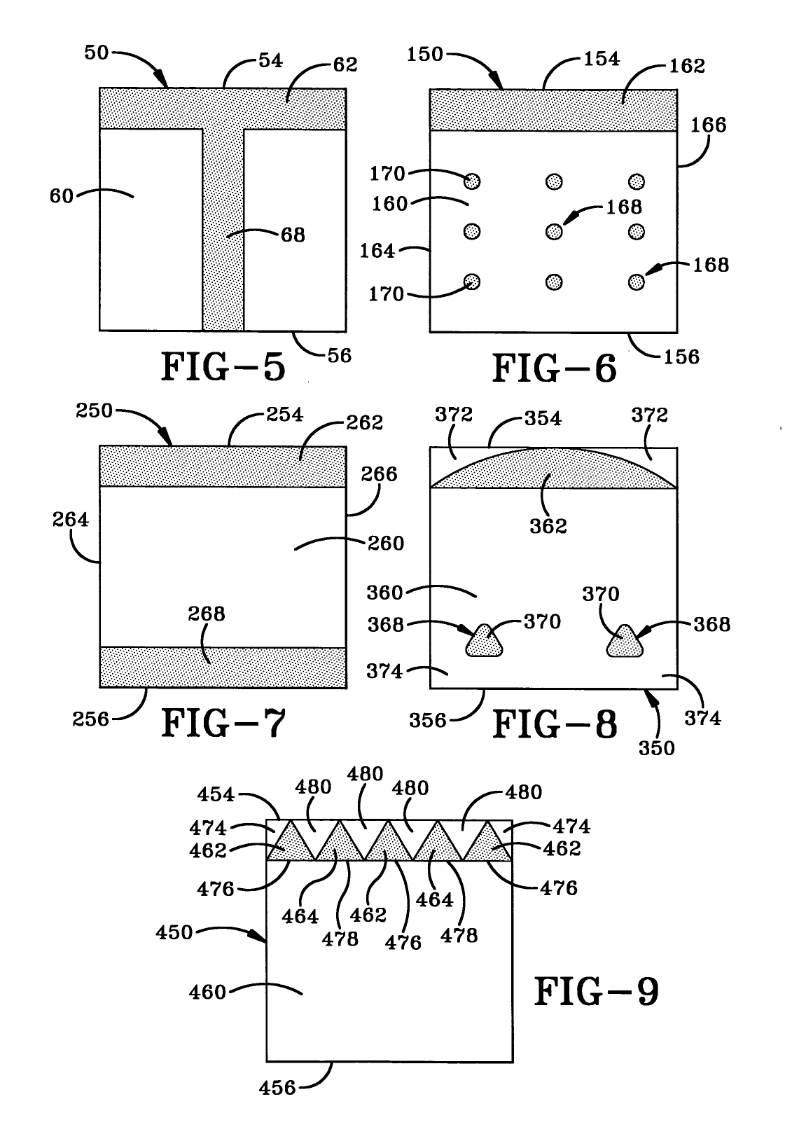

Referring to FIGS. 3-5, there is shown a first embodiment of a sheet of adhesive notepaper in accordance with the present invention and generally indicated at 50. Sheet 40 is applied to a surface 52. Sheet 50 has an upper edge 54, a lower edge 56, a front surface 58 and a rear surface 60. A first adhesive region 62 is applied proximate upper edge 54. First region 62 is a solid strip of adhesive applied from one side edge 64 to the other side edge 66. A second adhesive region 68 is applied to rear surface 60. Second region 68 is substantially perpendicular to first region 62 and lies generally proximate the middle of rear surface 60. Second region 68 preferably extends from lower edge 56 of sheet 50 and joins up with first region 62 thereby forming a T-shaped band of adhesive on the rear surface 60 of sheet 50. When sheet 50 is applied to surface 52 by pressing first and second regions 62, 68 into contact with surface 52, then, as can be seen in FIG. 4, little to no flagging of sheet 50 occurs.

A second embodiment of a sheet of adhesive notepaper is shown in FIG. 6 and generally indicated at 150. Sheet 150 has an upper edge 154 and lower edge 156. A first adhesive region 162 is applied to rear surface 160 of sheet 150 and extends from side edge 164 to side edge 166. A second adhesive region 168 is applied to rear surface 160 and comprises at least one and preferably a plurality of discrete beads 170 of adhesive. Beads 170 may be randomly scattered across rear surface 160, but preferably are positioned in spaced apart rows. It is also preferable that at least one of the rows of beads 170 is positioned proximate side edges 164 or 166 or proximate lower edge 156.

A third embodiment of a sheet of adhesive notepaper is shown in FIG. 7 and generally indicated at 250. Sheet 250 has a first adhesive region 262 applied to rear surface 260 proximate upper edge 265 and a second adhesive region 268 applied proximate lower edge 256. First and second regions 262, 268 preferably are solid strips of adhesive which extend from side edge 264 to side edge 266. First and second regions 262, 268 are substantially parallel to each other.

A fourth embodiment of a sheet of adhesive notepaper is shown in FIG. 8 and generally indicated at 350. Sheet 350 has a first adhesive region 362 applied proximate upper edge 354, but first region 362 is not a solid strip extending from side edge 364 to side edge 366. Instead, sheet 350 has upper corner areas 372 on rear surface 360 to which no adhesive is applied and areas 372 are consequently free of adhesive. The lack of adhesive in upper corner areas 372 reduces the tendency of sheet 350 to flag. Second adhesive region 368 comprises two discrete beads 370 positioned proximate lower edge 356 of sheet 350 and spaced slightly inwardly of lower corner areas 374.

A fifth embodiment of a sheet of adhesive notepaper is shown in FIG. 9 and generally indicated at 450. Sheet 450 has an upper edge 454 and a lower edge 456. A plurality of first and second adhesive regions 462 and 464 are applied to rear surface 460 of sheet 450 proximate upper edge 454. First and second regions 462, 464 preferably are triangular in shape and the bases 476 and 478, respectively, of the first and second regions are substantially coplanar. Areas 480 which are adhesive free separate first and second adhesive regions 462, 464. Additionally, upper corner areas 472 of sheet 450 preferably are adhesive free. The reduced amount of adhesive across rear surface 460 of sheet 450 proximate upper edge 454 tends to reduce the tendency of sheet 450 to flag.

The following description regarding use of the adhesive notepad uses the reference numbers for the first embodiment of the same, but it will be understood that all embodiments of the invention are used in a like manner. During manufacture, the first and second regions of adhesive 62, 64 are applied to the rear surfaces 60 of a plurality of sheets 50 of notepaper and the adhesive notepad (not shown) is formed by stacking the plurality of sheets 50 vertically one on top of the other. When a consumer wishes to use an individual sheet 50 of notepaper, the sheet 50 is removed from the notepad by grasping one of lower corners 74 (FIG. 3) and pulling the sheet 50 free from the notepad. Sheet 50 is then applied to an outer surface 63 of an object, such as a document, by bringing rear surface 60 of sheet 50 into contact with outer surface 63 and pushing first adhesive region 62 and second adhesive regions 64 into gripping contact therewith. As may be seen from FIG. 4, the tendency for sheet 50 to flag is greatly reduced and the rear surface 60 of sheet 50 stays substantially parallel to outer surface 63 along its entire length from upper edge 54 to lower edge 56. With respect to the fourth and fifth embodiments of the invention, the reduced amount of adhesive applied proximate the upper edge of the sheet tends to reduce the tendency of the sheet to flag.

It will be understood that the location and orientation of the first and second adhesive regions may be varied somewhat without departing from the scope of the present invention, providing the location and orientation of the adhesive regions allows substantially the entire length of the rear surface of the sheet to remain substantially in abutting contact with the outer surface of an object once the sheet is applied thereto. It will also be understood that with reference to the first embodiment of the invention, more than one strip may be applied as the second adhesive region lying perpendicular to the first adhesive region. Furthermore, the second adhesive region does not need to connect to the first adhesive region to form a T-shaped adhesive zone. A space may separate the first and second adhesive regions without departing from the spirit of the present invention.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An adhesive notepad comprising:
a plurality of sheets of notepaper, each having a front surface, a rear surface, an upper edge and a lower edge; and wherein the sheets of notepaper are stacked one on top of the other so as to form a notepad;
a first region of adhesive applied to the rear surface of each sheet of notepaper; and
a second region of adhesive applied to the rear surface of each sheet of notepaper at a spaced junction from the first region and oriented to cause substantially the entire length of the rear surface of a sheet of notepaper to lie substantially in abutting contact with the outer surface of an object to which that sheet is applied.

2. The adhesive notepad as defined in claim 1, wherein the first region of adhesive on each sheet lies parallel to the upper edge of the sheet and the second region of adhesive lies substantially perpendicular to the first region of adhesive.

3. The adhesive notepad as defined in claim 2, wherein the second region of adhesive is applied substantially along a midline of the rear surface of the sheet.

4. The adhesive notepad as defined in claim 3, wherein the first and second regions of adhesive are connected to form a T-shape.

5. The adhesive notepad as defined in claim 4, wherein the second region of adhesive extends from the first region of adhesive to the lower edge of the sheet.

6. The adhesive notepad as defined in claim 2, wherein the rear surface of each sheet of notepaper includes upper corners and lower corners, and wherein the upper corners of the sheet have an adhesive applied to them and the lower corners of the sheet are free of adhesive.

7. The adhesive notepad as defined in claim 1, wherein the second region of adhesive is spaced apart from the first region of adhesive.

8. The adhesive notepad as defined in claim 7, wherein the second region of adhesive comprises a plurality of discrete beads of adhesive.

9. The adhesive notepad as defined in claim 8, wherein the beads of adhesive are disposed in a row and are spaced apart from each other.

10. The adhesive notepad as defined in claim 9, wherein the beads of adhesive are disposed in a plurality of spaced apart rows.

11. The adhesive notepad as defined in claim 10, wherein each sheet of notepaper has side edges and at least one of the rows of beads is applied to the rear surface of the sheet proximate the side edges thereof.

12. The adhesive notepad as defined in claim 11, wherein at least one of the rows of beads is applied to the sheet proximate the lower edge thereof.

13. The adhesive notepad as defined in claim 1, wherein the second region of adhesive is disposed proximate the lower edge of the sheet of notepaper.

14. The adhesive notepad as defined in claim 13, wherein the first and second regions of adhesive each comprise a solid strip of adhesive and the two strips of adhesive are substantially parallel to each other.

15. The adhesive notepad as defined in claim 1, wherein each sheet of notepaper includes upper and lower corners and the first region of adhesive is applied proximate the upper edge of the sheet of notepaper, but the upper corners of the sheet are free of adhesive.

16. The adhesive notepad as defined in claim 15, wherein the second region of adhesive comprises a discrete bead of adhesive applied proximate each lower corner of the sheet of notepaper.

17. The adhesive notepad as defined in claim 1, wherein a plurality of alternating first and second regions of adhesive are applied to the rear surface of the sheet proximate the upper edge thereof; and wherein the first and second regions of adhesive are substantially separated from each other by areas free of adhesive.

18. The adhesive notepad as defined in claim 17, wherein each of the first and second regions of adhesive is triangular in shape and the bases of the triangularly-shaped first and second regions are substantially coplanar.

19. The adhesive notepad as defined in claim 18, wherein each sheet of notepaper includes upper corners which are free of adhesive.

20. An adhesive notepad comprising:
a plurality of sheets of notepaper, each having a front surface, a rear surface, an upper edge, a lower edge and first and second side edges; and wherein the sheets of notepaper are stacked one on top of the other so as to form a notepad;
a first adhesive region applied to the rear surface of each sheet of notepaper and extending between the first and second side edges;
at least one area free of adhesive disposed within the first adhesive region.

21. The adhesive notepad as defined in claim 20, further comprising:
a second adhesive region applied to the rear surface of each sheet of notepaper at a spaced junction from the first region and oriented to cause substantially the entire length of the rear surface of a sheet of notepaper to lie substantially in abutting contact with the outer surface of an object to which that sheet is applied.

22. The adhesive notepad as defined in claim 21, wherein the at least one area free of adhesive is disposed proximate a corner of each sheet of notepaper.

23. The adhesive notepad as defined in claim 22, wherein at least a second area free of adhesive is disposed proximate a second corner of each sheet of notepaper.

24. The adhesive notepad as defined in claim 20, wherein a plurality of areas free of adhesive are disposed at intervals within the first adhesive region.

25. The adhesive notepad as defined in claim 24, further comprising:
a second adhesive region applied to the rear surface of each sheet of notepaper at a spaced junction from the first region and oriented to cause substantially the entire length of the rear surface of a sheet of notepaper to lie substantially in abutting contact with the outer surface of an object to which that sheet is applied.
